(19) United States
(12) Patent Application Publication
(10) Pub. No.: US 2003/0206729 A1
(43) Pub. Date: Nov. 6, 2003

(54) Imaging system for authoring a multimedia enabled disc

(75) Inventors: Alexander C. Loui, Penfield, NY (US); Joseph Lentz, Kendall, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/459,745

(22) Filed: Jun. 12, 2003

Related U.S. Application Data
(63) Continuation-in-part of application No. 09/885,577, filed on Jun. 20, 2001.

(51) Int. Cl. H04N 5/781

(52) U.S. Cl. 386/125

(57) ABSTRACT

An imaging system for authoring a multimedia disc. The imaging system includes: a receiving area for receiving a digital imaging device and forming a communication link with the digital imaging device adapted to transmit digital data to the imaging system; a processor for processing the digital data received from the digital imaging device; a storage memory for storing the digital data received from the digital imaging device; an operating system for controlling the operation of the processor and the storage memory; a disc member adapted to write or record a multimedia enabled disc; a multimedia image authoring software application operating under the operating system for composing and authoring an image slideshow using at least one image transmitted to the imaging system from the digital imaging device and controlling the recording of the image slideshow on the multimedia enabled disc using the disc member; and at least one selection member for controlling the operation of the multimedia image authoring software application.

### CROSS REFERENCE TO RELATED APPLICATION

This is a Continuation-in-Part of U.S. Ser. No. 09/885,577, entitled “IMAGING SYSTEM FOR AUTHORING A MULTIMEDIA ENABLED DISC”, filed on Jun. 20, 2001 in the names of Loui et al., and which is assigned to the assignee of this application.

### FIELD OF THE INVENTION

The invention relates generally to the field of digital graphics albums, and more particularly to an imaging system and method for authoring a multimedia enabled disc comprising a multimedia digital graphics albums.

### BACKGROUND OF THE INVENTION

The use of digital cameras has increased in recent years. Accordingly, the volume of commercial and consumer held digital image files has also increased. Much like the problem of a closet full of shoe boxes of randomly held photographic prints, in the digital environment, there are computer “shoe boxes” full of randomly stored digital images. This leads to problems in locating and categorizing digital files, particularly digital files of graphical images, that is, digital graphics files.

A traditional photo album stores photographic prints. These photographic prints are placed in the album and often times annotated to identify particular information about the photographic print. An electronic photo album has been developed to store digital graphics images in a way similar to the traditional photo album. Eastman Kodak Company has developed digital graphic album applications, such as the Kodak Picture Page or the Kodak Memory Album software, which allows a user to organize digital graphics images into album pages. Typically, users organize images by date, time, places, subject, and so forth. The software may allow a user to annotate the digital graphics image by entering text or other information describing the digital graphics image.

Typically, traditional photo albums contain photographs taken by the owner/user, and perhaps some photographs taken by others. In contrast, an electronic photo album may contain digital graphics images from many sources other than the owner/user of the electronic photo album. For example, the digital graphics image might be taken with a digital camera, or it might be a photographic print scanned and converted to digital format. Alternatively, the digital graphics image might be created electronically, such as with a graphic software program or photo editing software program. There are private and commercial sources of digital graphics images, for example, stock photo agencies and shared photo resources such as the internet. Digital graphics images can be accessed via the internet, downloaded to a personal computer, and placed in a digital graphics album.

There are many options to organize and annotate digital graphics images in a digital graphics album. Digital graphic album software allows a user to do this manually. Though some software programs include features which provide some automation in the organization of the digital graphic images.

However, to provide a digital graphics album which is rich and full in its context and presentation, and to expand a viewer's enjoyment when viewing such an album, it may be desired to provide a multimedia digital graphics album. That is, it may be desired to include in a single digital graphics album, more than just digital still images and computer generated graphics. For example, it may be desired to include in the digital graphics album such items as video clips, audio clips, and voice annotations.

Further, it may be desired to transfer the digital graphics album to another digital media, for example a multimedia enabled disc, so that the album can be viewed using popular, commercially available consumer equipment, and can be played on a variety of consumer equipment, including consumer audiovisual equipment and a computer.

Still further, it may be desired to include PC-based software applications and/or digital images on the multimedia enabled disc containing the album, thereby providing a disc which is compatible both with a PC and consumer equipment.

Still further, it may be desired to provide an imaging system and method to facilitate and/or automate the authoring of the multimedia digital graphics album and the multimedia disc.

Methods have been disclosed for multimedia authoring, however, the references are not directed to the authoring of multimedia digital graphics albums. For example, U.S. Pat. No. 5,592,602, (Edmunds et al.) is directed to authoring tools for manipulating screen objects during the authoring of multimedia art. U.S. Pat. No. 5,907,704 (Gudmundson et al.) is directed to a system for authoring interactive multimedia applications. U.S. Pat. No. 5,515,490 (Buchanan et al.) is directed to a system and method for the automatic temporal formatting of multimedia documents.

Software applications are available for personal computers for multimedia authoring. For example, Ulead VideoStudio V5.0 provided by Ulead Systems Incorporated is described at www.ulead.com. This software application enables a user to create, for example, MPEG-2 output files from various input sources including digital video, JPEG still images, and audio MP3 and CD clips. This software application, however, does not automatically record the output files on an optical disc, nor does it produce, from the same input files, a plurality of different output files.

Accordingly, a need continues to exist for an imaging system and method to facilitate and/or automate the authoring of the multimedia digital graphics album and the multimedia disc.

### SUMMARY OF THE INVENTION

An object of the present invention is to provide an imaging system and method to facilitate and/or automate the authoring of the multimedia digital graphics album and the multimedia disc.

This object is given only by way of illustrative example. Thus, other desirable objectives and advantages inherently achieved by the disclosed invention may occur or become apparent to those skilled in the art. The invention is defined by the appended claims.

According to one aspect of the invention, there is provided an imaging system for authoring a multimedia disc. The imaging system includes: a receiving area for receiving a digital imaging device and forming a communication link with the digital imaging device adapted to transmit digital data to the imaging system; a processor for processing the digital data received from the digital imaging device; a storage memory for storing the digital data received from the digital imaging device; an operating system for controlling the operation of the processor and the storage memory; a disc member adapted to write or record a multimedia enabled disc; a multimedia image authoring software application operating under the operating system for composing and authoring an image slideshow using at least one image transmitted to the imaging system from the digital imaging device and controlling the recording of the image slideshow on the multimedia enabled disc using the disc member; and at least one selection member for controlling the operation of the multimedia image authoring software application.

The present invention provides an imaging system and method to facilitate and/or automate the authoring of the multimedia digital graphics album and the multimedia disc.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIGS. 1a and 1b show flow diagrams of methods in accordance with the present invention.

FIG. 2 shows a system in accordance with the present invention.

FIG. 3 shows a flow diagram of a method in accordance with the present invention when a background image comprises the digital graphics album.

FIG. 4 shows a flow diagram of a method in accordance with the present invention when a video clip comprises the digital graphics album.

FIG. 5 shows a flow diagram of a method in accordance with the present invention when a video clip is transcoded.

FIG. 6 shows the disc structure.

FIG. 7 shows a track of the disc structure of FIG. 7.

FIG. 8 shows the storage to provide a PictureCD compatible directory structure.

FIG. 9 shows a flow diagram of a method in accordance with the present invention wherein the multimedia material of the digital graphics album comprises a plurality of images, at least one background image, at least one audio clip, at least one video clip, at least one textual/graphic material, and at least one annotation by the user.

FIG. 10 shows an MPEG encoder.

FIG. 11 shows an isometric view of an exemplary imaging system in accordance with the present invention.

FIG. 12 shows various features of the imaging system of FIG. 11.

FIGS. 13a-13c show alternate embodiments of the imaging system of FIG. 11.

FIGS. 14a and 14b show a front view of a digital imaging device received within the receiving area of the imaging system of FIG. 11.

### DETAILED DESCRIPTION OF THE INVENTION

The following is a detailed description of the preferred embodiments of the invention, reference being made to the drawings in which the same reference numerals identify the same elements of structure in each of the several figures.

The term multimedia refers to the inclusion or involving of several media. Thus, multimedia material comprises a plurality of media material, and is intended to provide a digital graphics album with a rich and full context and presentation, and expand a viewer's enjoyment when viewing such an album. Such multimedia material can include, but is not limited to images, audio, video, and any combination thereof.

The present invention provides a system and method for the authoring of a multimedia digital graphics album which can be played on a variety of consumer equipment, including consumer audiovisual equipment and a personal computer. The present invention also provides a system and method for authoring a multimedia enabled disc comprising computer-based content (such as a personal computer) as well as a multimedia digital graphics album. For example, the computer-based content of the disc may comprise the original images/video/audio of the album (i.e., the original content of the album). If the original content is disposed on the same disc as the album, the original content can be readily shared, transferred, viewed, printed, emailed, and/or used in a website. By way of illustration, after the viewing of the album on consumer equipment, a viewer may desire to obtain a print of one of the images viewed in the album. If the original content is disposed on the disc, the viewer can readily obtain the desired image by using the disc with a personal computer.

Similarly, the computer-based content of the disc may comprise a software application, such as a computer game. Thus, a single multimedia disc may comprise both the software application (for playing on a PC) and the multimedia digital graphics album (for playing in consumer equipment).

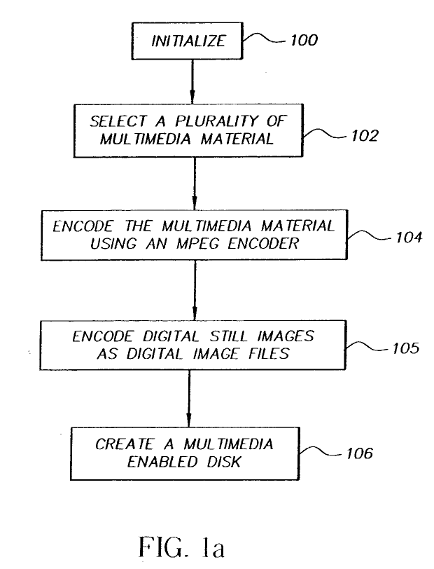

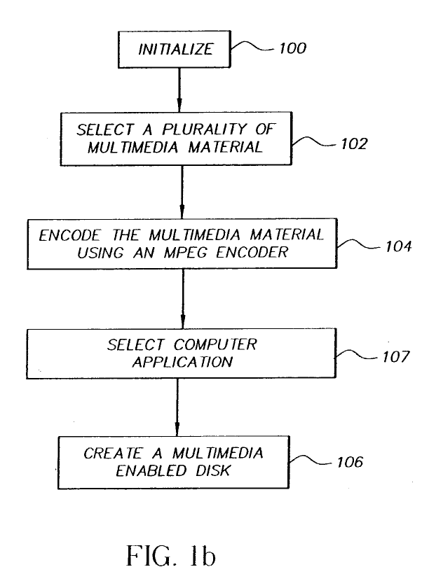

FIGS. 1a and 1b provide flow diagrams of methods in accordance with the present invention for the authoring of a multimedia enabled disc comprising computer-based content and a multimedia digital graphics album. As discussed above, the computer-based content can include original content, digital images which are not employed in the album, and/or a computer application.

For the flow diagram of FIG. 1a, the computer-based content of the disc comprises at least one digital image employed in the multimedia digital graphics album. As seen in FIG. 1a at step 100, the method is initialized. The multimedia material is selected (step 102) to generate the multimedia digital graphics album. Once selected, the multimedia material is encoded using an MPEG encoder (step 104). At step 105, digital still images employed in the multimedia material are encoded as digital image files, for example as a JPEG digital image file. A multimedia-enabled disc is created (step 106). Steps 100-106 are more particularly described below.

For the flow diagram of FIG. 1b, the computer-based content of the disc comprises a computer application. As seen in FIG. 1b at step 100, the method is initialized. The multimedia material is selected (step 102). Once selected, the multimedia material is encoded using an MPEG encoder (step 104). At step 107, the computer application is selected. The multimedia-enabled disc is created (step 106). Steps 100-107 are more particularly described below.

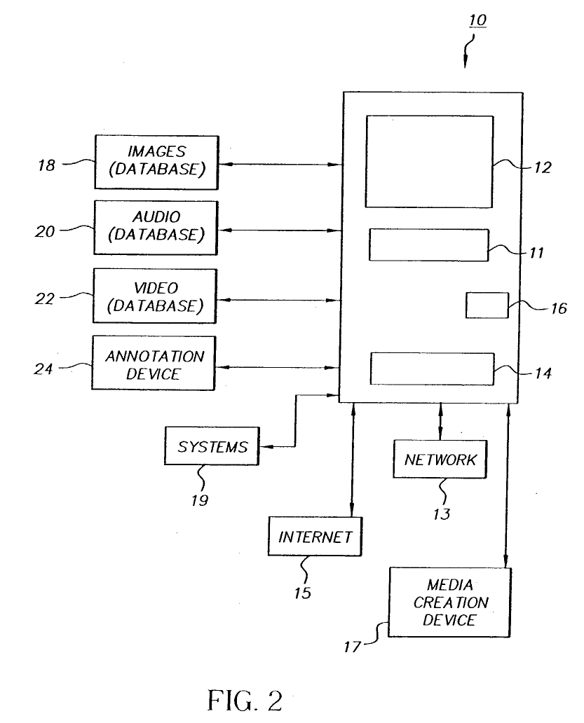

A system 10 in accordance with the present invention is illustrated in FIG. 2. System 10 comprises a processing unit 11 and an input device 12 for communicating with the user. Preferably, input device 12 is a screen or monitor having a touch screen interface, though alternatively, a keyboard 14 or other input device (such as a mouse or track ball) may be used by the user. System 10 can be a stand-alone system or network connected 13. Further, the system can be located within a home or located outside a home, such as at a retail store, professional photo studio, or other business venue. If located within a home, system 10 can be comprised of a home personal computer. If located outside of the home, system 10 could be comprised of a kiosk such as a Kodak Picture Maker or the like. If network connected, the connections may be disposed within or outside processing unit 11. Connections to the Internet 15 may be desirable, as would connections to other systems 19, such as to a photofinisher or a kiosk such as a Kodak Picture Maker. The multimedia material can include digital images, audio, and video, either taken alone or in any combination. Therefore, system 10 may include an input port 16 to provide/acquire digital images, audio, and video. Examples of input port 16 include a CD drive, a DVD-ROM drive, a flash card or memory card reader, a floppy disk drive, a microphone, and the like. System 10 further includes a media creation device 17 for producing a recordable optical disc such as a CD/DVD writer for the creation of the multimedia-enabled disc at step 106.

Referring now to FIGS. 1a, 1b, and 2, at step 100 the method for creating a multimedia enabled disc is initialized. The initialization includes the launching of the authoring application in a graphics user interface (GUI) based operating system.

At step 102, a plurality of multimedia material, including a plurality of digital still images, is selected for the inclusion in the multimedia digital graphics album. Techniques have been disclosed for searching and selecting digital graphical materials. For example, commonly assigned application U.S. Ser. No. 09/642,534 (Kodak Docket No. 80237), entitled “SYSTEM AND METHOD FOR ACQUISITION OF RELATED GRAPHICAL MATERIAL IN A DIGITAL GRAPHICS ALBUM”, filed on Aug. 18, 2000 in the names of Loui, Judice, and Cok, and which is assigned to the assignee of this application, incorporated herein by reference, discloses an apparatus and method for identifying, searching and selecting digital graphical materials for use in supplementing digital graphics albums. U.S. Pat. No. 5,493,677 to Balogh et al., entitled “GENERATING, ARCHIVING, AND RETRIEVAL OF DIGITAL IMAGES WITH EVOKED SUGGESTION-SET CAPTIONS AND NATURAL LANGUAGE INTERFACE”, incorporated herein by reference, is directed to archiving and retrieving of images, such as digitized photographs, works of art, or graphic illustrations, by use of a natural language such as English.

The images may be provided from various sources, represented in FIG. 2 as images 18. Such images could be taken with a digital camera, that is, digital still images. Alternatively, a digital still image can be acquired from an image taken with photographic film wherein the image is printed, scanned and converted to digital format. Such digital still images could be stored on a floppy disk, compact disc, memory card, or flash card. System 10 may utilize input port 16 as a means to input the digital still images. Images 18 of system 10 could include an image database comprised of images, which are theme-specific, for example scenes from a wedding, birthday party, baby birth, and graduation. The database could also comprise images of a regional interest, for example, scenery of popular tourist attractions, national monuments, national parks, and historic sites. Further, images can comprise cartoon characters, animations, and graphical art. Similarly, the images may be selected from other sources available by means of the Internet, network, or other systems.

Input formats for images 18 include BMP, DCS, DIB, EXIF, FlashPix, IMPS, JPEG, JPEG 2000, PhotoCD, PPM, TIFF, and Raw image formats.

A background image might be desired. That is, a background image might be desired for a title page, index sheet, and/or for bordering/framing the other images, similar to how a wallpapered wall borders/frames a picture hanging on the wall. As with the input formats for digital still images, the input formats for the background image include BMP, DCS, DIB, EXIF, FlashPix, IMPS, JPEG, JPEG 2000, PhotoCD, PPM, TIFF, and Raw image formats.

Audio material may also be included, and is represented in FIG. 2 as audio 20. As with images 18, audio 20 can be selected for various sources. For example, a system in accordance with the present invention may include an audio database having a plurality of audio clips with different genres such as light music, classical, rock, and theme-specific, e.g., music suitable for wedding, birthday party, baby birth, and graduation. System 10 may utilize input port 16 to provide means to permit the input of audio in digital form, for example, from a memory card, flash card, or other similar device. Such an input port allows a user to provide personally composed music compositions. The audio material may be selected from other sources available by means of the Internet, network, or other systems.

In addition to music, the audio database may comprise voice clips. For example, quotes from well-known novels, plays, or movies, and voices from well-known personalities such as actors, actresses, and politicians. Using input port 16, a user may provide personal voice clips. For example, if input port 16 comprised a microphone, personal voice clips could be recorded. This feature may be used when a user desires to annotate their images using a digital camera. As such, each image will include an associated speech file (e.g., a .wav file). A resulting multimedia digital graphics album having this feature would be similar to or have the feeling of a narrated slide show.

Input formats for audio include Wave file, MP3, Music CD audio, Apple/SGI formats (.AIFF, .AIF), Sun audio (.AU), and Creative Lab format (.VOC).

Video material may also be included. The video can be selected from various sources, represented in FIG. 2 as video 22. For example, system 10 in accordance with the present invention may include a video database. The database could comprise a plurality of video clips, which are theme-specific, for example scenes from a wedding, birthday party, baby birth, and graduation. The input of video might be accomplished using input port 16. For example, from a floppy disk, memory card, flash card, or other similar device. Such an input port allows a user to provide personally composed video compositions. The video images may be selected from other sources available by means of the Internet, network, or other systems.

The video could be provided as a moving background, and may or may not be accompanied by audio. Alternatively, the video can be comprised of a plurality of still images, and may or may not be accompanied by audio.

Input formats for video include MPEG-1, MPEG-2 , MPEG-4, H.261, H.262, H.263, CCIR 601 (digital video standard), AVI (MS Windows media format), Quicktime, DV (from digital video camcorders), and real video (Real Network).

An additional feature of the system is the inclusion of an annotation device 24. That is, a device for text annotation in real time. The annotations can be included as part of a title or for captioning of the multimedia digital graphics album. For example, for speech input, annotation device 24 can comprise a microphone and a built-in speech-to-text engine which converts the speech into text. Such an annotation device preferably includes an interface (e.g. a keyboard) to allow the user to make corrections.

The databases (for images, audio, or video) may be an existing database comprised of stock images, or a private database. A stock database generally requires the user to pay a copyright fee for access to the graphical materials, and perhaps a basic subscription fee might be imposed.

Once the plurality of multimedia material has been selected at step 102, the selected multimedia material is encoded using an MPEG encoder at step 104 thereby generating the multimedia digital graphics album which can be viewed by various consumer equipment, such as a VCD, SVCD, or DVD player.

In FIG. 1a, the digital still images which where selected in step 102 (i.e., as part of the multimedia material) are also encoded, at step 105, as separate digital image files, for example as JPEG files. The encoding of the digital still images at step 105 enables the digital image files to be used by a computer. For example, these files would be viewed, transferred, and/or printed. Preferably, the digital still images remain as high-resolution images, such as when the image was originally captured in a digital camera or first scanned by a photofinisher. Accordingly, step 105 provides the computer-based content of the disc.

In FIG. 1b, the computer-based content for the disc is obtained at step 107 wherein the computer application is selected.

MPEG (Moving Picture Experts Group) is an ISO committee responsible for defining various video specifications. Well-known encoding standards from MPEG include MPEG-1, MPEG-2 , and MPEG-4.

MPEG-1 is an audiovisual encoding standard (ISO 11172) for compressing digital video at low bit rates. MPEG-2 is designed for broadcast television and other applications using interlaced images. These MPEG standards are described in “Coding of moving pictures and associated audio for digital storage media at up to 1.5 Mb/s: video”, ISO/IEC 11172-2, MPEG-1 Video International Standard, 1993, and “Information technology—Generic coding of moving pictures and associated audio information: Video”, ISO/IEC 13818-2, MPEG-2 Video International Standard, 1996.

The selection of the MPEG standard (i.e., MPEG-1 or MPEG-2) used to encode the selected multimedia material depends on the multimedia enabled disc which is to be created, as discussed below.

The MPEG encoding can be implemented using a software encoder application or a hardware encoder board. The implementation method selected may vary by cost, speed, and image quality, and accordingly, the implementation method selected will depend on the requirements of the multimedia-enabled disc. For example, MPEG-1 encoding generally demands less computational resources than MPEG-2. Software encoding has become available in recent years as a result of improved performance of personal computers. With the level of encoding required (i.e., still images of several seconds each), software encoding may be preferred as it may be more cost effective to implement.

Once encoded, the multimedia-enabled disc is created at step 106. Writers/generators, such as for CD-R and DVD-recordable discs, are commercially available devices, and therefore referenced in FIG. 2 as media creation device 17. Such devices can be purchased for home use. To enable a fast writing process, high-speed writers (better than 4×) are preferred.

Various multimedia enabled discs may be created at step 106, for example, a VCD (video compact disc), a SVCD (super video compact disc), or a DVD (digital video disc). Players for each of these examples of a multimedia-enabled disc are available as consumer audiovisual equipment. VCD was developed by the VCD Consortium (including Philips, Sony, Matsushita, and JVC), and is based on MPEG-1 encoding. SVCD is based on MPEG-2 encoding, and was developed by China's Ministry of Information Industry (MII) in collaboration with the VCD Consortium, and has evolved into an international standard IEC 62107. DVD is also based on MPEG-2 encoding, and was developed by the DVD Forum, comprising approximately 220 member companies. Both VCD and SVCD use CD media, whereas DVD uses DVD media. VCD provides an image resolution of 352×240 (NTSC), or 352×288 (PAL) and can hold up to 74 minutes of audiovisual content. SVCD provides an image resolution of 480×480 (NTSC), or 480×576 (PAL), and can hold from 30-74 minutes of audiovisual content, depending on the compression bit rate. DVD provides an image resolution of 720×480 (NTSC), or 720×576 (PAL), and can hold up to 133 minutes of audiovisual content.

Accordingly, when a VCD is desired, a VCD image is created and a final VCD is burned (using media creation device 17), preferably along with a pre-defined menu. Similarly, when a SVCD is desired, a SVCD image is created and a final SVCD is burned (using media creation device 17), preferably along with a pre-defined menu. Likewise, when a DVD is desired, a DVD image is created and a final DVD is generated (using media creation device 17), preferably along with a pre-defined menu.

As noted above, either MPEG-1 or MPEG-2 encoding may be preferred dependent on whether a VCD, a SVCD, or a DVD is the desired output. For example, MPEG-1 is used for VCD, and while MPEG-2 is used for SVCD or DVD.

The multimedia-enabled disc can comprise a plurality of multimedia material, and more particularly, a plurality of combinations of multimedia material. For example:

(1) images; no background image; no audio; no video;

(2) images; a background image; no audio and no video;

(2) images; no background image; audio; no video;

(3) images; no background image; no audio; video;

(4) images; background image; audio; no video;

(5) images; background image; audio; video; and

(6) images; no background image; audio; video;

wherein the audio may be comprised of voice only (for example, per image), music only, or a combination thereof.

Other combinations will be known to those skilled in the art. Depending on the combination of multimedia material selected for the generation of the multimedia enabled disc, further steps may be required to format/prepare the multimedia material to provide a quality digital multimedia graphics album.

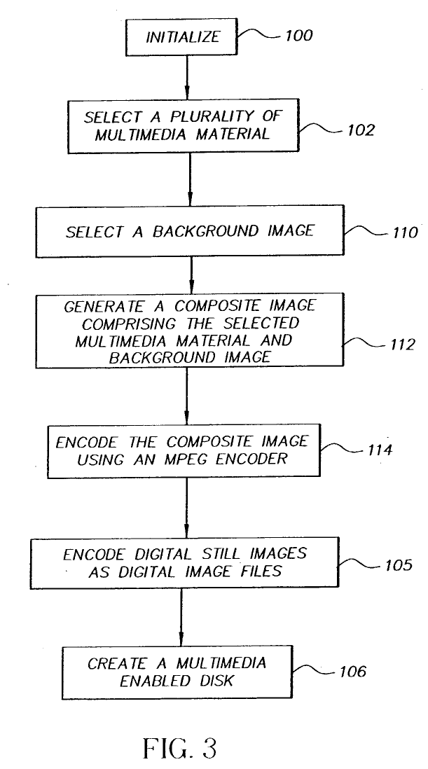

For example, if a background image is desired, any images selected at step 102 (i.e., the selection of the multimedia material) need to be composited with the background image prior to the MPEG encoding step. FIG. 3 shows a method in accordance with the present invention which is suitable for when a background image is to be included in the multimedia digital graphics album. As shown in FIG. 3, the method is initialized (step 100) and the plurality of multimedia material, including a plurality of digital still images, is selected (step 102). Further, a background image is also selected (step 110). A composite image is generated at step 112, with the composite image comprising the multimedia material and the background image. The composite image is encoded using the MPEG encoder (step 114), each of a plurality of digital still images are also encoded as digital image files (step 105), and the multimedia enabled disc is generated (step 106) by recording the MPEG encoded composite image and digital image files on the disc. (Step 105 is replaced with step 107 is a software application is to be employed rather than digital still images.)

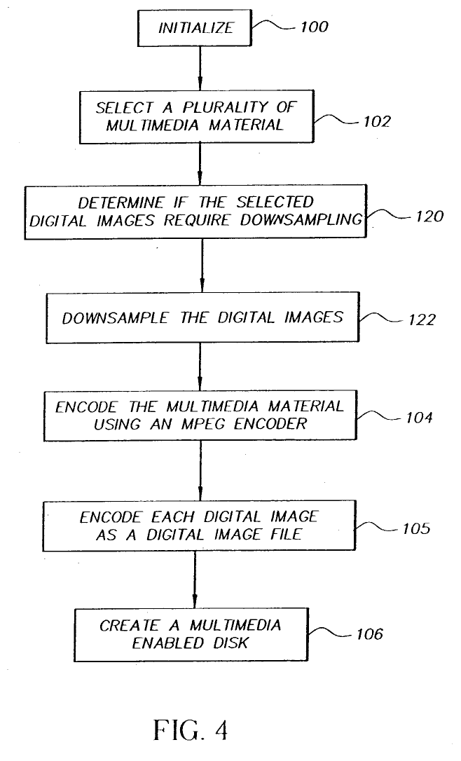

For some high-resolution digital still images, it may be necessary to downsample the digital still images prior to MPEG encoding. FIG. 4 shows a method in accordance with the present invention which is suitable for when high resolution images are used as input to the multimedia digital graphics album. As shown in FIG. 4, the method is initialized (step 100) and the plurality of multimedia material is selected (102), which includes selecting a plurality of digital still images. Further, it is determined whether the selected digital still images require downsampling (step 120) in order to provide an appropriately sized image for incorporation into the MPEG bitstream. If required, the digital still images are downsampled (step 122) prior to the multimedia material being MPEG encoded (step 104). The downsampling preferably includes low pass filtering followed by decimation. The original high-resolution digital still images are encoded as separate high resolution digital image files (step 105). The multimedia enabled disk is created (step 106) by recording the MPEG bitstream and encoded digital image files on the recordable disc. (Step 105 is replaced with step 107 is a software application is to be employed rather than digital still images.)

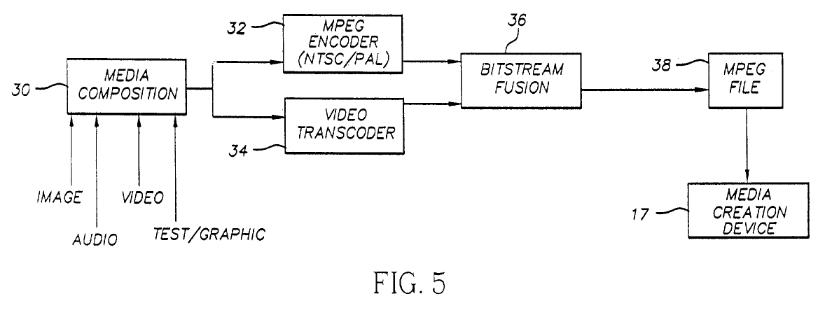

Further, video which is selected as part of the multimedia material (step 102) could already be provided in a MPEG format, but the resolution of the selected video might not match the resolution required for the output MPEG bitstream. In this instance, the video is transcoded using a video transcoder. FIG. 5 shows a flow diagram illustrating the incorporation of a video transcoder 34. As illustrated, rather than directing the video through an MPEG encoder 32, the selected video is directed by media composition 30 through video transcoder 34. Once transcoded, the video bitstream and MPEG bitstream are re-united and concatenated in bitstream fusion 36 to create a single MPEG file 38 which can be recorded using media creation device 17.

Depending on the multimedia enabled disc to be created, video transcoder 34 will transcode the input video into the appropriate format with the right resolution and bit rate. For example, if the multimedia enabled disc to be created is VCD, MPEG-1 video needs to be encoded at 1.152 Mbps constant bit rate, the image resolution must be 352×240 at 29.97 Hz (NTSC) or 352×288 at 25 Hz (PAL). Also, the MPEG-1 audio needs to be encoded at 224 Kbps using layer 2 encoding scheme. The requirement will be different for DVD, which is based on the MPEG-2 encoding.

Different transcoding techniques have been disclosed in research literature. Examples of references for the design and implementation of video transcoder include: “Architecture for MPEG compressed domain bitstream scaling”, by Sun et al., IEEE Trans. Circuits and Systems for Video Technology, Vol 6, pp. 191-199, April 1996; “Transcoding of MPEG bitstreams”, by Keesman et al., Signal Processing: Image Communications, Vol. 8, pp. 481-500, September 1996.

Other MPEG files may need to be joined (e.g. concatenated) to provide a final MPEG file for creation of the multimedia enabled disc. Such joining is required when several MPEG bitstreams are to be included as part of the multimedia enabled disc. For example, if multiple digital graphics albums are to be merged into a single album, the MPEG bitstreams would be concatenated consecutively in bitstream fusion 36. A single MPEG file would then be written into one single track of the disc structure using media creation device 17. Alternatively, multiple MPEG files can be used for creation of the multimedia enabled disc. In this instance, each of the MPEG files will be written into a separate track of the disc structure. Each track will correspond to a separate event or album in the disc.

The multimedia-enabled disc is preferably configured as a normal compact disc so that it can be viewed and manipulated on a personal computer as well as being used as a VCD, SVCD, or DVD. Accordingly, for a VCD, a normal CD-ROM file structure with high-resolution images and other software applications (for example, as provided with a Kodak Picture CD) is included as in a standard compact disc so that the digital still images included in the MPEG bitstream can also be accessed as JPEG files so that they can be viewed and manipulated on a personal computer.

Creation of the multimedia-enabled disc (step 106) includes writing the normal disc-ROM structure onto the optical disc. For example, for a VCD, the normal CD-ROM structure is written onto the recordable optical disc. For a DVD, the DVD-ROM structure is written.

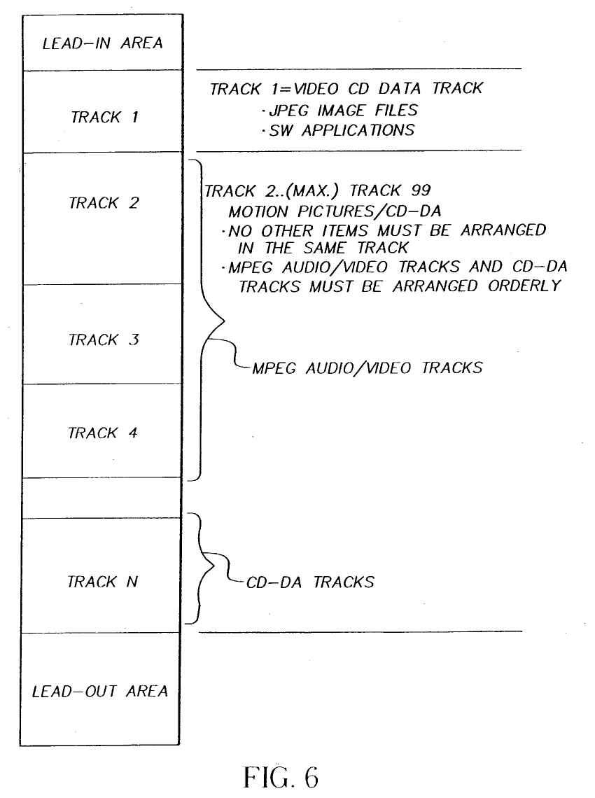

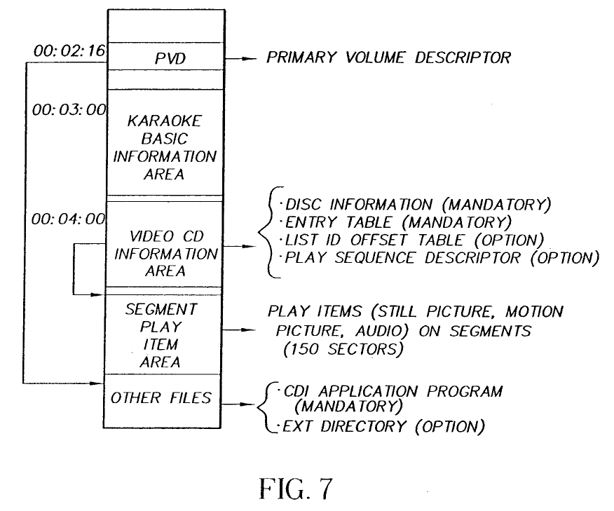

The high resolution digital image files encoded as digital image files, preferably encoded as JPEG digital image files, are written into Track 1 of the disc structure, shown in FIG. 6 as a VCD disc structure. In accordance with the disc standard, Track 1 area contains the disc information area, the ISO 9660 (CD-ROM) file structure, and other options such as Segment Play Item area. A more detailed breakdown of the information recorded in Track 1 is depicted in FIG. 7.

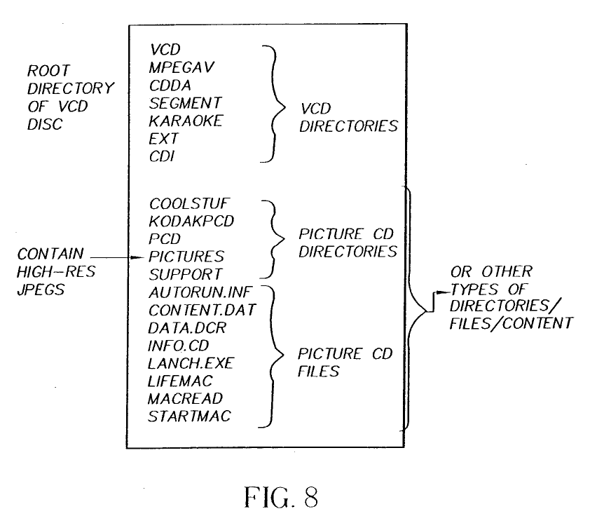

As discussed above, the encoding of the digital still images of the original content at step 105 enables the digital image files to be used by various consumer equipment, such as personal computer, and by image editing software applications. FIG. 8 shows an example of how the digital image files (i.e., the JPEG digital image files) and/or software application are stored for a VCD. A root directory structure of a VCD is illustrated. This directory provides a Kodak PictureCD compatible directory structure. The digital image files are stored in the “Pictures” directory shown in FIG. 8. Other software applications, such as for viewing and editing these digital image files, can be stored, for example, in the “Coolstuf” directory or other Picture CD directory. As a result, the multimedia enabled disc created in step 106 provides a Kodak Picture CD compatible disc, since the digital still images included in the MPEG bitstream for the multimedia digital graphics album are also stored separately as Picture CD compatible JPEG image files.

Alternatively, other files and software applications can be stored in place of the Picture CD content.

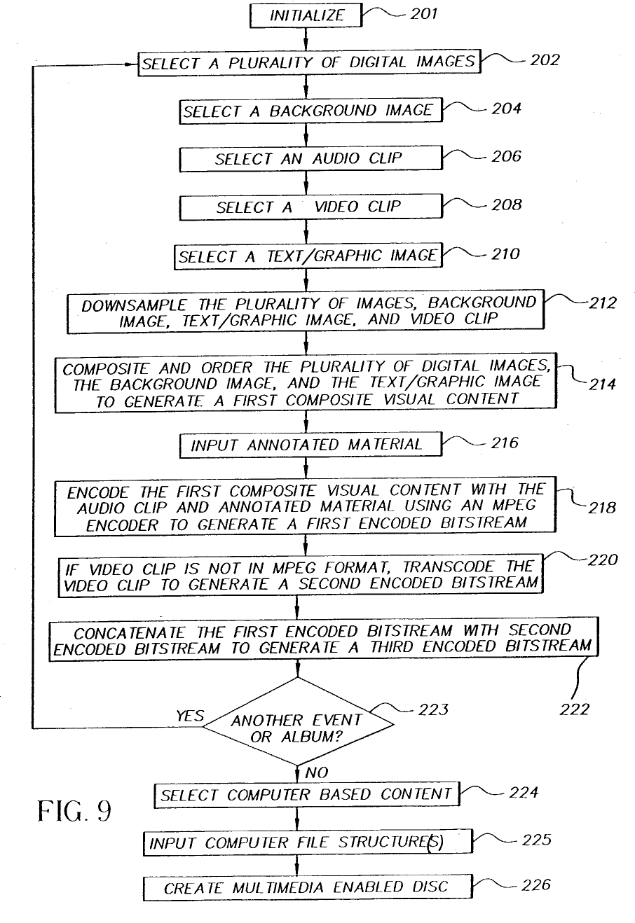

FIG. 9 provides a flow diagram of a method in accordance with the present invention wherein the multimedia material of the digital graphics album comprises a plurality of images, at least one background image, at least one audio clip, at least one video clip, at least one textual /graphic material, and at least one annotation by the user.

As illustrated in FIG. 9, at step 201, the system 10 for creating a multimedia digital graphics album is initialized. The initialization includes the launching of the authoring application in a graphics user interface (GUI) based operating system. At step 202, the user selects, using input device 12 or keyboard 14, a plurality of digital images for inclusion in the multimedia digital graphics album. At step 204, the user selects using the input device 12 or the keyboard 14, a background image. Similarly, the user selects one or more audio clips (step 206), one or more video clips (step 208), and at least one text or graphic image (step 210). System 10 then downsamples the plurality of images (step 212), including the background image, text/graphic image, and video clip. At step 214, system 10 composites and orders the plurality of downsampled digital images, the background image, and the text/graphic image to generate a first composite visual content. If annotated material is to be included, the user inputs annotated material using annotation device 24 (step 216) using, for example, a microphone or text input. System 10 encodes the first composite visual content with the audio clip and annotated material using an MPEG encoder to generate a first encoded bitstream (step 218). At step 220, if a video clip is not in MPEG format, system 10 transcodes the video clip to generate a second encoded bitstream. System 10 then concatenates the first encoded bitstream with the second encoded bitstream to generate a third encoded bitstream (step 222). If another event or album is to be constructed, (step 223), steps 202 through 222 are repeated. If no further events/albums are to be constructed, at step 224 the computer-based content is selected. If the selected content is digital still images, these images are encoded at step 224 as digital image files. At step 225, the computer-ROM file structures is determined. At step 226, system 10 creates a multimedia-enabled disc including the computer-ROM file structures, computer-based content, and the final MPEG bitstream (which may be the third encoded bitstream of step 222 or a plurality of bitstreams if multiple events/albums were constructed at step 223).

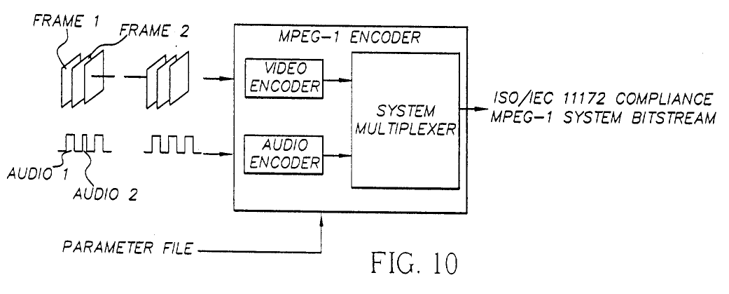

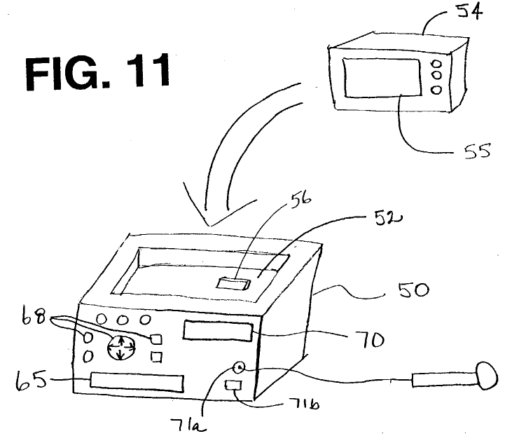

FIG. 10 depicts MPEG encoder 32 in more detail. As illustrated in FIG. 11, MPEG encoder 32 is composed of three sections: 1) video encoder, 2) audio encoder, and 3) system multiplexer. The encoding step includes inputting the image/video sequence in a frame by frame sequential order to the video encoder, and inputting the audio data that corresponds to the image/video sequence to the audio encoder. Accordingly, the audio is preferably corresponded image-by-image. A parameter file is also sent to encoder 32 from media composition 30, indicating for example the display duration for each of the digital still images of the input sequence. The encoded video and audio bitstreams are then multiplexed to form an ISO/IEC 11172 compliance MPEG system bitstream.

In MPEG-1 and MPEG-2 video encoding, each video frame is divided into an array of macroblocks, each 16,16 pixels in size and comprising 4 blocks of Y (luminance), 1 block each of U and V (color information). Therefore, the color information has half the horizontal and vertical resolution of the luminance information. For the constrained parameter systems, used for Video CD, there are a maximum of 396 macroblocks per frame. The Y, U, and V information in each macroblock is compressed, preferably using Discrete Cosine Transform (DCT) encoding and motion compensation.

An index or title page can be included in the multimedia digital graphics album. This can be accomplished by first selecting a title/index page background image, inputting text to describe the multimedia album, or inputting text to indicate the title for each MPEG files (tracks) created.

The digital still images to be encoded in a digital image file (at step 105) need not be the same digital still images selected as part of the multimedia material at step 102. Rather, the image or images comprising the computer-based content may be an image or plurality of images separate and distinct from any image employed in the digital graphics album. Accordingly, a method of providing an optical disc would then comprise the steps of selecting a first plurality of digital still images; selecting an audio clip; encoding the first plurality of digital still images and the audio clip as a single MPEG bitstream; selecting a second plurality of digital still images; encoding each of the second plurality of digital still images as a digital image file, each of the plurality of digital images files being a JPEG file; and recording the single MPEG bitstream and the plurality of digital image files on the optical disc.

Thus, the present invention discloses a method and a system to efficiently author and present digital graphics albums comprised of multimedia material. The multimedia enabled disc created by the present invention can be displayed and played, in addition to a personal computers, in consumer audiovisual equipment such as a VCD player, SVCD player, and DVD player. Features of the invention include: (1) automated operation with user selectable input; (2) easy association of audiovideo content and graphical material to digital images to create a multimedia digital graphics album; (3) viewing using consumer audiovisual equipment such as VCD, SVCD, and DVD players, while maintaining compatibility to a computer; (4) ready incorporation of existing photo products (such as Picture CD from Eastman Kodak Company) as a result of incorporating the computer file structure; (5) ready incorporation into a photofinishing process; and (6) utilization of consumer audio captured in digital cameras.

The present invention provides a means to improve the overall artistic presentation of a digital image. The efficient authoring of a multimedia digital graphics album enables the playback in popular consumer equipment such as VCD, SVCD, and DVD players. This method and system would be used during the creation of a multimedia-enabled Kodak Picture CD for consumers. The method and system will greatly enhance the value of the current Kodak Picture CD, as it provides an alternate path and a new experience to view digital photographs in consumer's living room rather than on a PC.

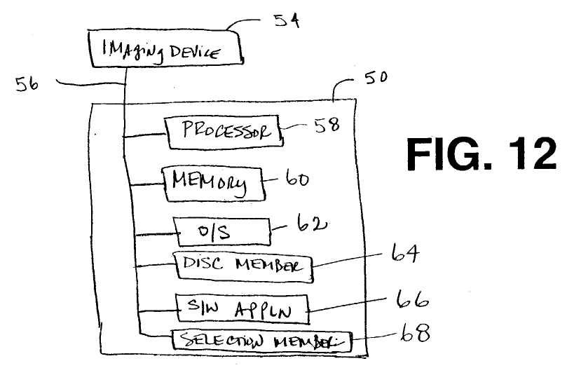

Referring now to FIGS. 11 and 12, there is shown an exemplary imaging system 50 in accordance with the present invention. Imaging system 50 includes a receiving area 52 adapted to receive a digital imaging device 54, for example, a digital camera, video camera, or a PDA with a camera. When digital imaging device 54 is received by imaging system 50, a communication link is formed between device 54 and system 50 whereby digital data from digital imaging device 54 can be transmitted to system 50. Means for forming such a communication link are well known to those skilled in the art and can include for example a port 56 such as a serial port, a USB port, or a FireWire (IEEE 1394) port. As will be more particularly described below, preferably receiving area 52 is configured to receive digital imaging device 54 such that a display 55 of digital imaging device 54 is viewable by a user operating imaging system 50.

System 50 further includes a processor 58 for processing the digital data received from digital imaging device 54, and a storage memory 60 for storing the digital data received from digital imaging device 54. An operating system 62 controls the operation of processor 58 and storage memory 60. Operating systems are well known to those skilled in the art, for example but not limited to, Windows, Windows CE, and Pocket PC (all from Microsoft), as well as UNIX, LINUX OS, and Palm™ OS.

System 50 also includes a disc member 64 adapted to write or record a disc, such as a CD, VCD, SVCD, DVD, or the like. Accordingly, system 50 can include an input port 65 for receiving a disc into disc member 64.

A multimedia image authoring software application 66 operating under operating system 62 is employed for composing and authoring a image slideshow (e.g., multimedia graphics album) using at least one image transmitted to imaging system 50 from imaging device 54 and controlling the recording of the image slideshow on a disc member using disc member 64.

System 50 further includes at least one selection member 68 for controlling the operation of multimedia image authoring software application 66. As shown in FIG. 11, selection member 68 can be configured as a button, joystick, 4-way controller, rotatable member, or the like as is known to those skilled in the art.

System 50 can optionally include a display 70 for displaying messages and/or instructions to a user and an audio input port 71 for receiving audio content. Such an audio input port can be configured as a microphone (shown in FIG. 11 at 71a), or a multimedia port (shown in FIG. 11 as 71b) for receiving a USB connector or removable medium such as a memory card, SD card, memory stick, compact flash card, or the like.

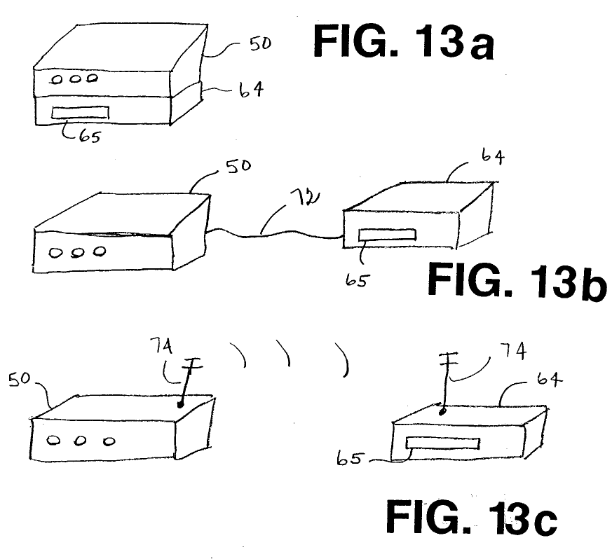

It is recognized that disc member 64 can be an element/component separate and distinct from the other elements/components of imaging system 50. For example, as shown in FIG. 13a, disc member 64 can have a shape complementing the shape of imaging system 50 such that disc member 64 and imaging system 50 can be stacked to form a single unit. Configuring elements/components as complementary shapes is described in U.S. Ser. No. 10/393,834 filed on Mar. 21, 2003 in the names of Manico et al., commonly assigned, incorporated herein by reference. Alternatively, disc member 64 can be in communication with imaging system 50 through a physical communication link/network 72, as shown in FIG. 13b, for example, USB, FireWire, or the like. In a further alternative, disc member 64 can be in communication with imaging system 50 through a wireless communication link/network 74, as shown in FIG. 13c, for example, Bluetooth, Wi-Fi, 802.11b or the like.

Imaging system 50 acts as a “dock” or “docking unit” for digital imaging device 54. Once “docked” within imaging system 50, digital images stored in digital imaging device 54 can be accessed to author the multimedia graphics album. In addition, the display 55 of digital imaging device 54 can be employed to operate/control imaging system 50, as will be described below. That is, features of digital imaging device 54 can be controlled and/or operated by imaging system 50.

In operation, a user stores images within digital imaging device 54. If digital imaging device 54 is a digital camera, then the user can capture digital images and store these images. If the digital camera provides such features, the user can annotate the stored images with audio clips, music content and the like. For example, the user can select/download MP3 music to the digital camera. The user can also review and edit the stored images.

Digital imaging device 54 is then received within receiving area 52 and communication link 56 is formed between imaging device 54 and imaging system 50. When communication link 56 has formed, the combination of digital imaging device 54 and imaging system 50 includes the features of system 10 (as shown in FIG. 2) and thereby operates similarly to system 10 to perform the methods shown in FIGS. 1a, 1b, 3, 4, 5, 9, and 10. (It is recognized that not all composition and authoring options may be present/included with imaging system 50. For example, a reduced or subset of features may be offered if processor 58 or memory 60 is limited.) Using selection member(s) 68 of imaging system 50, digital images stored in digital imaging device 54 can be accessed and reviewed on display 55.

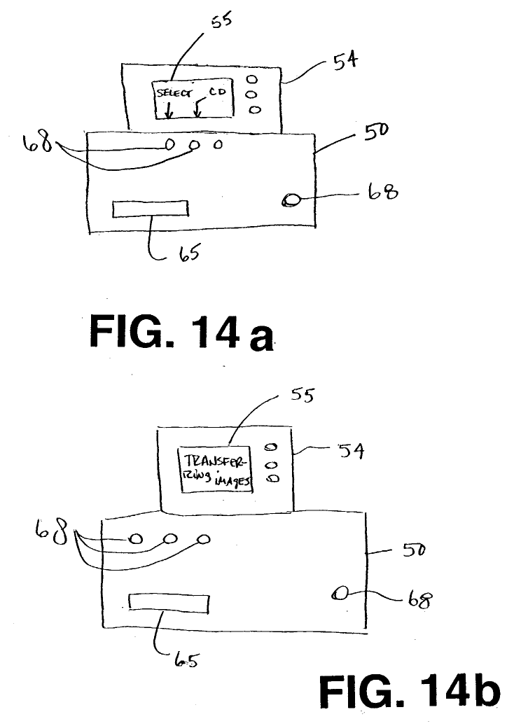

In addition, instructions displayed on display 55 can correspond with particularly selection member(s) of imaging system for authoring the multimedia-enabled disc. For example, as shown in FIG. 14a, specific instructions displayed on display 55 correspond with particular selection members 68 of imaging system 50. Alternatively, display 55 can be employed to display instructions/messages/information associated with the operation/control of imaging system 50. For example, as shown in FIG. 14b, a message displayed on display 55 indicates that images are being transferred from digital imaging device 54 to imaging system 50. Still further, display 70 can also be used to provide instructions or messages or status information.

Selection member(s) 68 are employed to author the image slideshow and multimedia enabled disc. In one arrangement, selection of a particular selection member 68 can automatically select all the digital images stored on digital imaging device 54 for inclusion in the slideshow. In another arrangement, a user can select particular/individual images stored on digital imaging device 54 for inclusion in the image slideshow.

One or more digital images can include a user-inputted speech annotation. The annotation can be included with the digital image using the digital imaging device 54 or, if using audio input port 71a, the particular digital image is selected using selection member 68 and the annotation is associated with the selected digital image.

To add music or other audio content, selection member 68 can be used to select the music. Candidate music selections can be displayed by filename on display 55 or display 70. Selection member 68 can also be used to simultaneously select both speech annotation and music content. Similarly, selection member 68 can be used to indicate transitions (or no transitions) between images.

Once the image slideshow composition is arranged, an output format is selected using selection member 68. Examples of output formats include CD, VCD (normal and high resolution), SVCD, and DVD. Once the output format is selected, the user using selection member 68 to encode and create the multimedia enabled disc, as described above with reference to steps 105 and 106.

In a preferred embodiment, the present invention is directed to an imaging system having a docking station for a digital camera. The imaging system includes a processor and memory for image processing and an embedded software application capable of authoring a multimedia disc. It is recognized that the included features of the software application for such an embodiment may be dependent on the processor speed and memory size.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

10 system

11 processing unit

12 input device

13 network

14 keyboard

15 internet

16 input port

17 media creation device

18 image; database

19 systems

20 audio; database

22 video; database

24 annotation device

30 media composition

32 MPEG encoder

34 video transcoder

36 bitstream fusion

38 MPEG file

50 imaging system

52 receiving area

54 digital imaging device

55 display; digital imaging device

56 port to form communication link/network

58 processor

60 storage memory

62 operating system

64 disc member

65 input port for disc member

66 authoring software application

68 selection member

70 display; imaging system

71a input port

71b input port

72 communication link/network

74 wireless communication link/network

What is claimed is:

1. An imaging system for authoring a multimedia enabled disc, comprising:
a receiving area for receiving a digital imaging device and forming a communication link with the digital imaging device adapted to transmit digital data to the imaging system;
a processor for processing the digital data received from the digital imaging device;
a storage memory for storing the digital data received from the digital imaging device;
an operating system for controlling the operation of the processor and the storage memory;
a disc member adapted to write or record a multimedia enabled disc;
a multimedia image authoring software application operating under the operating system for composing and authoring an image slideshow using at least one image transmitted to the imaging system from the digital imaging device and controlling the recording of the image slideshow on the multimedia enabled disc using the disc member; and
at least one selection member for controlling the operation of the multimedia image authoring software application.

2. The imaging system of claim 1, further comprising a display .

3. The imaging system of claim 1, further comprising an audio input port for receiving audio content.

4. The imaging system of claim 1, wherein the imaging system includes:
a first unit member comprising the receiving area, the processor, the storage memory, the operating system, the multimedia image authoring software application and the at least one selection member; and
a second unit member comprising the disc member, wherein the first unit member and second unit member have complementary shapes such that the first and second unit members are stackable.

5. The imaging system of claim 1, wherein the imaging system includes:
a first unit member comprising the receiving area, the processor, the storage memory, the operating system, the multimedia image authoring software application and the at least one selection member;
a second unit member separate from the first unit member and comprising the disc member; and
a communication link providing communication between the first unit member and the second unit member.

6. The imaging system of claim 5, wherein the communication link is a wireless communication link.

7. The imaging system of claim 5, wherein the communication link provides a physical communication link.

8. The imaging system of claim 1, wherein the multimedia enabled disc is a VCD compatible optical disc.

9. The imaging system of claim 1, wherein the multimedia enabled disc is a SVCD compatible optical disc.

10. The imaging system of claim 1, wherein the multimedia enabled disc is a DVD compatible optical disc.

11. The imaging system of claim 1, wherein the digital imaging device includes a display, an the imaging system further comprising means for controlling the display of the digital imaging device when the digital imaging device is received within the receiving area of the imaging system.
